(19) United States
(12) Patent Application Publication
(10) Pub. No.: US 2017/0358831 A1
(43) Pub. Date: Dec. 14, 2017

(54) BATTERIES WITH THERMAL MANAGEMENT

(71) Applicant: Pure Watercraft, Inc., Seattle, WA (US)

(72) Inventors: David Milroy, Seattle, WA (US); Andrew H. Rebele, Seattle, WA (US); Christopher M. Gil, Seattle, WA (US)

(21) Appl. No.: 15/612,774

(22) Filed: Jun. 2, 2017

Related U.S. Application Data
(60) Provisional application No. 62/349,481, filed on Jun. 13, 2016.

(51) Int. Cl. H01M 10/63; H01M 10/613; H01M 10/658; H01M 10/615; H01M 10/6556; H01M 10/0525

(52) U.S. Cl. CPC H01M 10/63; H01M 10/6556; H01M 10/0525; H01M 10/658; H01M 10/615; H01M 10/613; H01M 2220/20

(57) ABSTRACT

A battery pack assembly includes: a battery cell; a flat heat pipe, coupled to the battery cell, configured to transfer thermal energy to or from the battery cell; and a thermal electric cooler, coupled to the flat heat pipe, configured to cool the battery cell based on reducing the thermal energy through the flat heat pipe.

### RELATED APPLICATION(S)

This application claims the benefit of and priority of 62/349,481, titled “BATTERY THERMAL MANAGEMENT SYSTEM,” and filed Jun. 13, 2016. The subject matter thereof is incorporated herein by reference thereto.

### TECHNICAL FIELD

The disclosed embodiments relate to electrical batteries, and, in particular, to electrical batteries with a thermal management mechanism.

### BACKGROUND

The demand for electrical energy is growing rapidly as new devices and functions become available to consumers. For example, technical growth and increasing usage of mobile devices and electric vehicles are driving the demand for portable source of electrical energy, such as electrical batteries.

Many types of batteries are affected by extreme temperatures, which can lead to a variety of problems including decrease in capacity, electrical and/or structural failure, shortened battery life, etc. Further, electrical battery packages (e.g., Lithium-ion (Li-ion) battery packs) generate significant heat during charging and discharging operations. To prevent problems caused by the self-generated heat, conventional systems have implemented refrigeration cycle (i.e., vapor-compression cycle), latent heat storage, and air cooling to manage the heat generated by the batteries.

However, the conventional methods all have some drawbacks. For example, the use of refrigeration cycles either require that an evaporator be pervasive to the battery pack, or require cooling a liquid or gas that is circulated throughout the battery pack. The compressor required for the refrigeration cycles include electric motors, which are noisy and further becomes additional sources of potential failures. Also for example, the latent heat storage method (i.e., relying primarily on phase change material (PCM)) requires large amount of time because there tends to be a small temperature difference between a phase-change temperature and a worst-case environmental temperature. Further, once the PCM becomes thermally saturated, temperature of the battery pack can rise without limit. Also for example, the air cooling method relies on environmental temperatures to manage the heat of the battery packs. As a consequence, the air cooling method can be less effective based on changes in the temperature of the surrounding environment.

Other methods (e.g., as described in U.S. Pat. No. 8,658,299) use Peltier coolers that transfer heat through a thermally conductive structure with a heat-exchanging fluid to manage the heat. However, these methods also have their deficiencies since they rely on energy that would be dissipated through resistors for cooling.

Thus, there is a need for batteries with a thermal management mechanism. In view of the ever-increasing commercial competitive pressures, along with growing consumer expectations and the desire to differentiate products in the marketplace, it is increasingly desirable that answers to these problems be found. Additionally, the need to reduce costs, improve efficiencies and performance, and meet competitive pressures adds an even greater pressure to find these answers.

### BRIEF DESCRIPTION OF THE DRAWINGS

FIG. 1A is a profile view of a battery pack assembly in accordance with an embodiment of the present technology.

FIG. 1B is a cross-sectional view of the battery pack assembly taken along a reference line 1-1 of FIG. 1A in accordance with an embodiment of the present technology.

FIG. 2A is an isometric view of the battery pack assembly of FIG. 1 with the solar shield.

FIG. 2B is an isometric view of the battery pack assembly of FIG. 1 without the solar shield of FIG. 1 in accordance with an embodiment of the present technology.

FIG. 3A is an isometric view of a battery module connected to a heat sink in accordance with an embodiment of the present technology.

FIG. 3B is an isometric view of the battery module in accordance with an embodiment of the present technology.

FIG. 3C is a profile view of the battery module with the heat sink in accordance with an embodiment of the present technology.

FIG. 3D is a cross sectional view of the battery module taken along a reference line 3-3 of FIG. 3C in accordance with an embodiment of the present technology.

FIG. 3E is an enlarged partial view of the battery module shown in FIG. 3D in accordance with an embodiment of the present technology.

FIG. 4 is a thermal block diagram of the battery pack assembly of FIG. 1 in accordance with an embodiment of the present technology.

FIG. 5 is a schematic view of a system that includes a battery pack assembly in accordance with embodiments of the present technology.

### DETAILED DESCRIPTION

The technology disclosed herein relates to a device for controlling the temperature within a battery pack (e.g., a Li-ion battery pack) using a thermal conductor (e.g., a flat heat pipe) and a thermal-electric device (e.g., a thermal electric cooler (TEC) or a resistive heater). For example, the thermal energy can be transferred from battery cells to the TEC through the flat heat pipe. The flat heat pipe can be arranged vertically, with the TEC attached at a top portion of the flat heat pipe and the battery cells attached below the TEC, for improving transfer of thermal energy and for evenly cooling the battery cells. The battery cells can further be arranged symmetrically around the thermal heat pipe for further ensuring even cooling for the battery cells.

The thermal-electric device can adjust the thermal energy level of the battery pack outside of a discharge cycle (i.e., when the energy stored in the battery pack is used as a supply or a source for a device or system), such as during a charge cycle or a resting state (i.e., when the battery pack is neither charged nor used). For example, the TEC can use power from an external source (i.e., a power outlet or a solar panel) to pre-cool the battery pack prior to the discharge cycle.

In some embodiments, the TEC can further cool the battery pack during the discharge cycle using the power from the external source (i.e. the solar panel or a different battery), from within the battery pack, or a combination thereof. In some embodiments, the resistive heater can use power from the external source to maintain a temperature level within the battery pack above a temperature level of a cold environment.

To control the internal temperature, the thermal conductor can be coupled to the thermal-electric device and one or more battery cells of the battery pack in order to transfer the thermal energy between the thermal-electric device and the battery cells. For example, the TEC can contact the flat heat pipe or be coupled using a thermally conductive attachment (such as a mechanical fastener or a thermally conductive adhesive). Also for example, the flat heat pipe can be similarly coupled to the battery cells. The thermal conductor can also be electrically isolated from the battery cells, such as using a thermally-conductive electrical-insulator located between the flat heat pipe and the battery cells or electrical connectors thereof. For example, the flat heat pipe can be anodized or coated through other means for electrical insulation. Also for example, the flat heat pipe can be located away from electrical contacts or wires.

In some embodiments, the battery pack can further include a thermal storage unit (e.g., phase change material (PCM)) for further regulating the temperature within the battery pack, such as during the discharge cycle. The thermal storage unit can be thermally coupled to the battery cells, the flat heat pipe, or a combination thereof. For example, the PCM can store the thermal energy generated during the discharge cycle, and the TEC can be used to cool the PCM along with the battery cells outside of the discharge cycle.

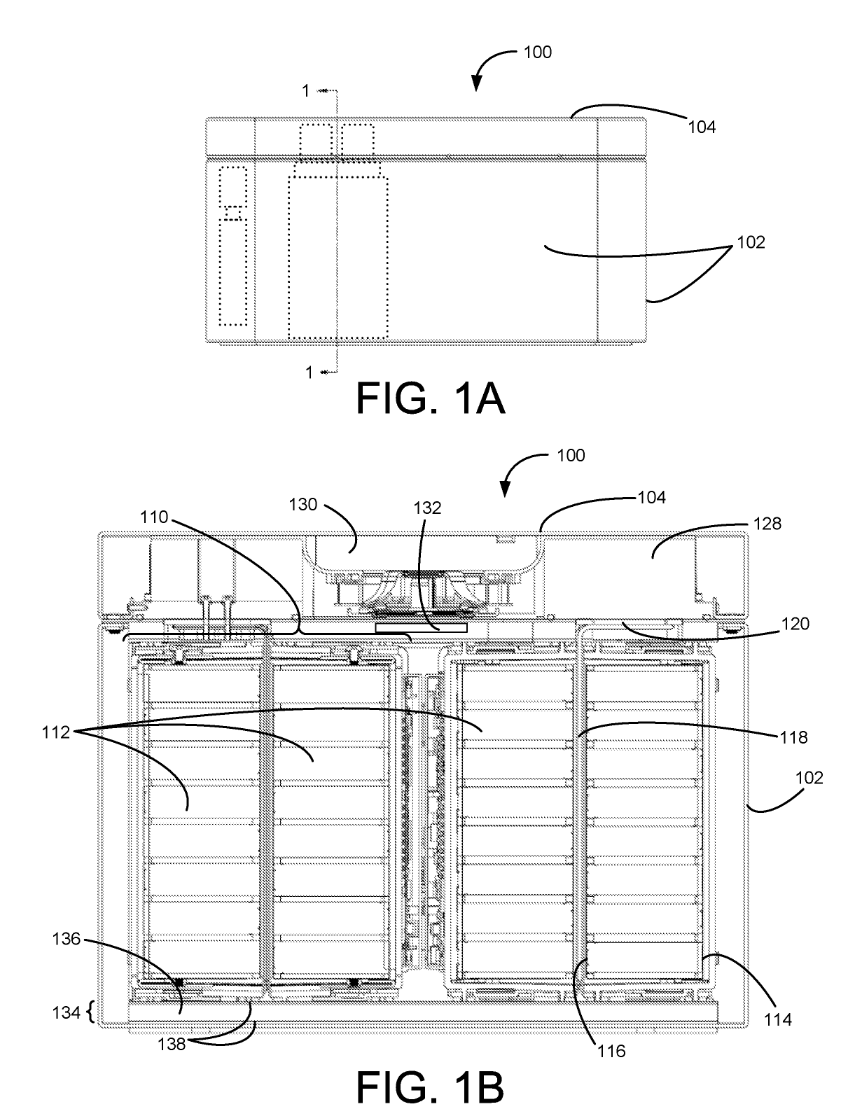

FIGS. 1A-1B illustrate a battery pack assembly 100 in accordance with an embodiment of the present technology. The battery pack assembly 100 is a device or a structure that stores and supplies electrical energy. The battery package assembly 100 can include components and mechanisms for facilitating the storage and supply of the electrical energy and for managing the internal temperatures.

As shown in FIG. 1A, a profile view of the battery pack assembly 100 in accordance with an embodiment of the present technology, the battery pack assembly 100 can include a housing 102 and a solar shield 104. The housing 102 can form peripheral walls or structures of the battery pack assembly 100 and encompass the circuitry and the components of the battery pack assembly 100. The housing 102 can be thermally insulated to reduce heat transfer between the content of the battery pack assembly 100 and the environment. In some embodiments, the thermal insulation can be greater (i.e., the thickness of the housing 102 can be greater) at a top portion or surface of the housing 102 than the vertical side portions or the bottom portion of the housing 102.

Connected to the housing 102, the solar shield 104 can be located at a top portion of the battery pack assembly 100 for blocking the contents of the battery pack assembly 100 from direct exposure to sun light. In some embodiments, the solar shield 104 can include a solar panel or have a separate solar panel (not shown) attached on the top surface thereof. The electrical energy generated by the solar panel can be used to cool the internal components of the battery pack assembly 100 during the discharge cycle.

The battery pack assembly 100 can include one or more battery modules and a high-voltage unit (i.e., a structure shown as being located between the battery module and a front portion of the housing 102). The high-voltage unit includes circuitry configured to control high-voltage electrical energy associated with the battery pack assembly 100 (e.g., a contactor unit including electrical relays, regulators, control logic, etc.). The high-voltage unit can be thermally isolated from the battery modules (i.e., separated by a thermal-insulator encasing the battery cells).

As shown in FIG. 1B, a cross-sectional view of the battery pack assembly 100 taken along a reference line 1-1 of FIG. 1A, the battery pack assembly 100 can include mechanisms, devices, or structures for facilitating the storage and the usage of electrical energy. For example, the battery pack assembly 100 can include a mechanism to regulate the thermal energy therein, inter alia, by pre-cooling battery cells before a discharge cycle.

The battery pack assembly 100 can include one or more battery modules 110 that each represent a structural unit configured to store and manage the electrical energy. Each of the battery modules 110 can store and supply the electrical energy using battery cells 112 (e.g., Li-ion cells including “18650” rechargeable batteries) therein. In some embodiments, the battery cells 112 can have cylindrical shapes or prism shapes (i.e., polyhedrons with two identical n-sided polygonal bases and n-number of sides or faces joining the two bases) where anodes and cathodes are located on a first base surface 114 and a second base surface 116, respectively.

During usage (e.g., during charge and discharge cycles), the battery cells 112 can generate significant amount of heat. As such, each of the battery modules 110 can further include components and/or circuitry for managing the thermal energy of the battery cells 112 therein. For example, the battery modules 110 can include one or more thermal conductors 118 and one or more thermal-electric devices 120 coupled to the battery cells 112. The thermal conductors 118 are structures (e.g., flat heat pipes) configured to transfer thermal energy between connected structures. The thermal-electric devices 120 are devices configured to change the temperature (i.e., by heating or cooling) of the surrounding environment. The thermal-electric devices 120 can include Peltier devices (e.g., thermal electric coolers (TEC), thermoelectric heat pump, heater, etc.) each configured to create a heat flux between two different types of materials using electrical energy.

The battery modules 110 can manage the thermal energy of the battery cells 112 by operating the thermal-electric devices 120 to cool or heat the surface or portion thereof interfacing with the thermal conductors 118. For example, in cooling the battery cells 112, the thermal conductors 118 can transfer the thermal energy from the connected battery cells 112 to a cold portion of the TEC. The battery modules 110 can operate the TEC to remove the thermal energy from the cold portion. The thermal energy can be transferred to a hot portion of the TEC, which can be connected to one or more heat sinks 128 located external to the housing 102, an enclosure of the battery modules 110, or a combination thereof. The heat sinks 128 can dissipate the thermal energy of the TEC, which includes the thermal energy generated by the battery cells 112 and transferred to the TEC through the flat heat pipe.

The battery module 110 can include a configuration of the thermal-electric devices 120, the thermal conductors 118, and the battery cells 112 for improving removal of thermal energy and for evenly removing the thermal energy from the battery cells 112. For example, the flat heat pipe can be arranged vertically with the TEC connected to a top portion thereof. The battery cells 112 can be arranged symmetrically with respect to the flat heat pipe (e.g., same number of batteries on opposing sides, same number of connections between each battery and the flat heat pipe, etc.), with either the anode or the cathode of each battery connected to the vertically extending portion of the flat heat pipe. The vertical orientation of the flat heat pipe improves the thermal transfer between the batteries and the TEC. Further, the symmetrical configuration of the batteries with respect to the flat heat pipe and the connection between the anode or the cathode (i.e., for the 18650 battery cells) and the flat heat pipe provides even cooling throughout each battery and across the battery cells. The even cooling can reduce or remove thermal gradients, thereby preserving the performance characteristics and extending the life of the batteries.

The battery pack assembly 100 can further include cooling ducts 130 for facilitating thermal management. The cooling ducts 130 can include openings or airways configured to dissipate thermal energy from the heat sinks 128, the thermal-electric device 120, or a combination thereof. For example, in the cooling ducts 130, the heat sinks 128 can be exposed to the environment, a coolant, ambient or forced air, or a combination thereof that can dissipate the thermal energy.

In some embodiments, the battery pack assembly 100 can use electrical energy from a source external thereto to operate the TEC, such as outside of the discharge cycle (i.e., during a charge cycle or a resting state) of the battery cells 112. The battery pack assembly 100 can use the external electrical energy to pre-cool the battery cells 112 before the discharge cycle. For example, pre-cooling can be implemented for the battery pack assembly 100 used to power electric vehicles (e.g., boats, cars, or drones with electric motors). As the vehicle remains in storage (e.g., at a dock, a parking stall or garage, or a charging station), the battery pack assembly 100 can be electrically connected to a power outlet. The TECs can use the electrical energy from the power outlet to pre-cool the battery cells 112 (i.e., such as for lowering the internal temperature of the batteries below the ambient temperature to provide greater thermal budget for operating the batteries) before the cells are used to power the electrical vehicle. The TEC can also use the external energy to remove the thermal energy from the battery cells 112 that was generated during preceding operation of the electrical vehicle and/or while charging the battery cells 112.

In some embodiments, the TEC can be operated during the discharge cycle (i.e., while the battery cells 112 operate as a power source). For example, the TEC can operate using the electrical energy from the battery cells 112. Also for example, the TEC can operate using the electrical energy from a different external source connected to the battery pack assembly, such as the solar panel.

The battery pack assembly 100 can further include a control circuit 132 (i.e., in each of the battery modules 110 or for the entire assembly) configured to electrically manage and control the thermal-electric device 120, such as by controlling a magnitude or an intensity in the heating or cooling operation. For example, the control circuit 132 can turn the thermal-electric device 120 on and off, control a duty cycle, determine and operate only a select sub-set of the thermal-electric devices, controlling a setting or a level for the thermal-electric device 120, controlling an amount of energy supplied to the thermal-electric device 120, etc. The control circuit 132 can include digital or analog components, such as processors, field programmable gate arrays (FPGAs), voltage or current regulators or converters, passive components, etc. The control circuit 132 can also include environmental sensors, such as thermocouples, voltage or current reader, etc.

As an illustrative example, the control circuit 132 can allocate the incoming electrical energy between charging the battery cells 112 and operating the TEC while charging the battery cells 112. The control circuit 132 can set a cooling intensity or level for the TEC to balance a battery charging rate or time and the amount of thermal energy in the battery cells 112. The control circuit 132 can vary the cooling intensity or level of the TEC based on a variety of factors, such as a characteristic or rating of the external power source, an amount or type of the incoming energy, geographic location of the battery pack assembly 100, sensor or temperature readings, current energy levels in the battery cells 112, usage or consumption pattern, etc.

In some embodiments, the control circuit 132 can operate the TEC using the electrical energy stored in the battery cells 112. For example, the control circuit 132 can determine a trigger condition (e.g., based on an internal temperature reading, a pause in the discharge cycle, etc.) and accordingly operate a switch or a relay to route the electrical energy stored in the battery cells 112 to the TEC.

As an illustrative example, the control circuit 132 is shown separate from the battery modules 110. However, it is understood that the control circuit 132 can be included in each of the battery modules 110. In some embodiments, the control circuit 132 can be included within the high-voltage unit.

In some embodiments, the thermal conductors 118 can be connected to both base surfaces, one or more sides or faces orthogonal to or between the base surfaces, or a combination thereof. In some embodiments, the thermal conductors 118 can be connected to a thermal storage unit interfacing with the batteries.

In some embodiments, the control circuit 132 can reverse the polarity of the incoming electrical energy, thereby operating the thermal-electric device 120 to perform thermally opposite operations. For example, the control circuit 132 can reverse the polarity of the electrical energy supplied to the TEC to heat the battery cells 112 when the temperature inside the battery pack assembly 100 or the ambient temperature falls below a predetermined limit.

In some embodiments, the battery pack assembly 100 can include a reinforcement panel 134 (i.e., a structure configured to strengthen the structural integrity of the battery pack assembly 100, such as for resisting a physical force applied to the battery pack assembly 100). For example, the reinforcement panel 134 can include a compressible layer 136 between outer layers 138. As a more specific example, the reinforcement panel 134 can include a layer of wood (e.g., blocks or modules of wood connected by a layer of fiber or mesh), gel, or other soft material attached to the outer layers 138 made of rigid material, such as metal sheets.

For illustrative purposes, the battery pack assembly 100 is shown with the reinforcement panel 134 attached to a bottom portion of the housing 102. However, it is understood that the battery pack assembly 100 can include different configurations of the reinforcement panel 134. For example, the reinforcement panel 134 can be a part of or a portion within the housing 102. Also for example, the battery pack assembly 100 can include multiple reinforcement panels 134, such as for a top portion or one or more side portions of the battery pack assembly 100.

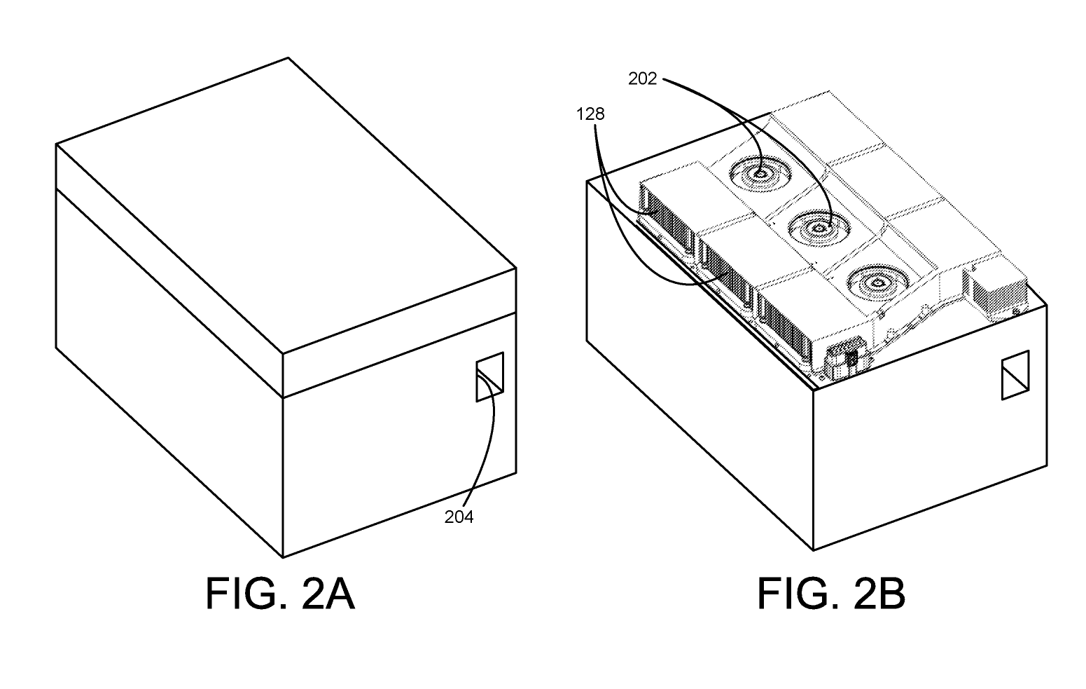

FIG. 2A is an isometric view of the battery pack assembly 100 of FIG. 1 with the solar shield 104 in accordance with an embodiment of the present technology. FIG. 2B is an isometric view of the battery pack assembly 100 of FIG. 1 without the solar shield 104 in accordance with an embodiment of the present technology. The heat sinks 128 can be located below the solar shield 104. The heat sinks 128 can be arranged with a channel or space between each heat sink (i.e., illustrated in FIG. 2 as the channel between two rows of the heat sinks 128 and/or the space between the heat sinks 128 within each row). Along with the solar shield 104, the channel or space can form the cooling duct 130 of FIG. 1.

The battery pack assembly 100 can include a thermal interface 202 connected to the channel or space. The thermal interface 202 includes a structure facilitating exchange of thermal energy between the internal portions of the battery pack assembly 100 and the environment thereof. For example, the thermal interface 202 can include an opening (i.e., air intake and/or air outlet), a blower or a fan, a pump, or a combination thereof. The thermal interface 202 can be connected to the cooling ducts 130 to cool the heat sinks 128 and dissipate the thermal energy within the battery cells 112 of FIG. 1.

In some embodiments, the battery pack assembly 100 of FIG. 1 can include a set of fans for the thermal interface 202. The fans can be configured to circulate air through the cooling duct 130 for evenly cooling the battery modules 110. The cooling duct 130 can further be configured to cool the battery modules 110 before the high-voltage control unit. For example, the fans and the cooling duct 130 can be configured to route the air across the heat sinks 128 and then to or through the high-voltage control unit.

The battery pack assembly 100 can further include an external power interface 204 (e.g., power plug and/or a charging circuitry) for accessing a power source external to the battery pack assembly 100. For example, the external power interface 204 can connect the battery pack assembly 100 to the external power source for charging the battery pack assembly 100, for powering the TEC as discussed above, or a combination thereof.

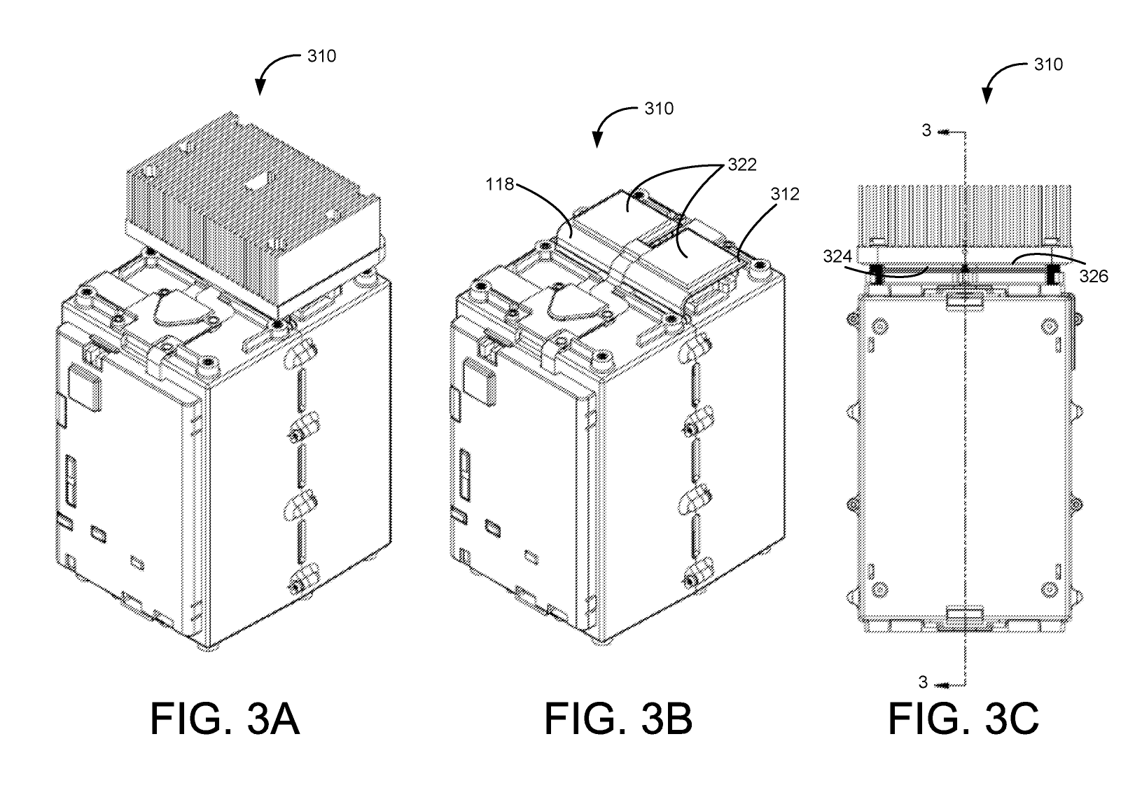

FIGS. 3A-3E illustrate a battery module 310 in accordance with an embodiment of the present technology. The battery module 310, as one of the battery modules 110 of FIG. 1, is a structural unit configured to store and manage the electrical energy. The battery module 310 can store or supply a predetermined amount of electrical energy (e.g., a rating or a limit for power, voltage, or current). The battery pack assembly 100 can include one or multiple instances of the battery module 310 according to an electrical energy requirement or specification.

FIG. 3A and FIG. 3B are isometric views of the battery module 310 with and without the heat sink 128 of FIG. 1, respectively. FIG. 3C is a profile view of the battery module 310. As illustrated, the battery module 310 can include an encasing. In some embodiments, the encasing can include structures, materials, shapes, or a combination thereof to thermally isolate the contents within the encasing from the surrounding environment. For example, the encasing can encompass and thermally isolate the battery cells 112 of FIG. 1 from the surrounding environment. In some embodiments, such as for the battery module 310 designed to operate in specific uses or environments, the encasing can be thermally conductive (i.e., using conductive material or vents).

The thermal conductor 118 (e.g., flat heat pipe) can extend out of the encasing, leaving a portion of the thermal conductor 118 exposed outside of the encasing. For example, the thermal conductor 118 can include an interface portion 312 exposed and outside of the encasing. Within the encasing, the thermal conductor 118 can be connected to the battery cells 112 as discussed above.

The battery module 310 can include the thermal-electric device 120 of FIG. 1, which can also be exposed from or external to the encasing. For example, the battery module 310 can include one or more TECs 322 (i.e., one type of the thermal-electric device 120 configured to use electrical energy to create a heat flux to cool or remove thermal energy) attached to the interface portion 312 of the thermal conductor 118. Each of the TECs 322 can include a cold portion 324 and a hot portion 326. The thermal conductor 118 can be attached to the cold portion 324 of the thermal conductor 118 and the hot portion 326 can be exposed and accessible outside of the encasing, such as for connecting or interfacing with the heat sinks 128.

For illustrative purposes, the interface portion 312 and the thermal-electric device 120 is shown above a top portion of the encasing in FIGS. 3A-3D. However, it is understood that the interface portion 312 and the thermal-electric device 120 can be located elsewhere relative to the encasing.

FIG. 3D is a cross sectional view of the battery module 310 taken along a reference line 3-3 of FIG. 3C in accordance with an embodiment of the present technology. Inside the casing, the battery module 310 can include the battery cells 112 connected to the thermal conductor 118. For example, the thermal conductor 118 can include a body portion 328 (i.e., shown in FIG. 3D as extending vertically between columns of the battery cells 112) that is integral with the interface portion 312. The body portion 328 can be connected to the battery cells 112 (e.g., at one of the base surfaces or at the anode or the cathode), and absorb the thermal energy from the connected battery cells 112. The absorbed thermal energy can be transferred to the interface portion 312 and then to the TECs 322 for removal or dissipation.

The battery module 310 can further include thermal storage units 330 (e.g., PCM that melt and solidify at a phase change temperature; thermal energy can be absorbed or released based on the change in physical states of the materials) connected to the battery cells 112. The thermal storage units 330 can be configured to store the thermal energy generated by the battery cells 112, such as during the discharge cycle, thereby managing or maintaining the temperature of the battery cells 112.

In some embodiments, the thermal storage units 330 can contact the battery cells 112 on one or more the faces or sides of the battery cells 112. For example, the thermal storage units 330 can contact one or more faces or sides, one or more base surfaces, or a combination thereof. The connection between the battery cells 112 and the thermal conductor 118 can be uncovered by or exposed from the thermal storage units 330. In some embodiments, the thermal storage units 330 can make radial contact with each battery cell. In some embodiments, the thermal storage units 330 can encompass or encase the faces or sides of prism shaped battery cells 112 while exposing the base surfaces that include the anode and the cathode.

In some embodiments, the thermal storage units 330 can further be connected to the thermal conductor 118, the further connection being separate from the connection between the thermal conductor 118 and the battery cells 112. The thermal storage units 330 can be independently connected to the thermal conductor 118, without any battery cells 112 intervening between the connected structures. The thermal conductor 118 can transfer the thermal energy to and/or from the thermal storage units 330 similarly as described above for the battery cells 112.

In some embodiments, the battery module 310 can include other thermal-electric devices. For example, the battery module 310 can include a resistive heater 332 coupled to the thermal conductor 118 and configured to pre-heat the battery cells 112 or to maintain a temperature above a threshold limit for cold environments. The resistive heater 332 can be located below the battery cells 112.

In some embodiments, the battery module 310 can include the battery cells 112 arranged symmetrically across the body portion 328 of the flat heat pipe. For example, the battery module 310 can include a first battery set 336 (i.e., a grouping of battery cells) and a second battery set 338 (i.e., a grouping of different battery cells). The first battery set 336 can be connected to a first surface of the flat heat pipe. The second battery set 338 can connected to a second surface, opposite the first surface.

For illustrative purposes, the battery module 310 is shown with one flat heat pipe between the first battery set 336 and the second battery set 338. However, it is understood that other symmetrical arrangements for the battery cells 112 and the heat pipes are available to one of ordinary skill in the art. For example, the first battery set 336 and the second battery set 338 can each be connected to two flat heat pipes such that both the anode and the cathode of each battery are connected to flat heat pipes.

FIG. 3E is an enlarged partial view of the battery module shown in FIG. 3D in accordance with an embodiment of the present technology. As shown in FIG. 3E, the thermal conductor 118 can be electrically isolated from the battery cells 112 using a thermally-conductive insulator 334 (e.g., thermally conductive pads, thermal adhesives, thermal grease or gel, laminates such as ‘G11’ material, or a combination thereof) located between the battery cells 112 and the thermal conductor 118. The thermally-conductive insulator 334 can also include an insulation layer applied (e.g., by coating) or formed (e.g., by anodizing) on the thermal conductor 118.

In some embodiments, the battery module 310 can include thermally conductive battery cells (e.g., Li-ion “18650” battery cells) that have lower thermal resistance along an axis. The thermal conductor 118 can be connected to a surface interfacing or intersecting the thermal axis (e.g., the first base surface 114 of FIG. 1 or the second base surface 116 of FIG. 1) to evenly control the temperature throughout the body of the battery cells 112. Based on the thermally conductive battery cells, the battery pack assembly 100 can uniformly remove heat from the battery and/or the PCM coupled to the battery while reducing or eliminating thermal gradients.

When the thermal storage units 330 are separately connected to the thermal conductor 118, the thermal electric cooler can remove the thermal energy directly from the thermal storage units 330. The thermal conductor 118 can couple to the thermal storage units 330 at multiple locations according to a configuration for uniformly removing heat from the PCM while reducing or eliminating thermal gradients.

The TEC 322 coupled to the battery cells 112 using the thermal conductor 118 (i.e., using the flat heat pipe as discussed above) improves the cooling efficiency of the TECs in multiple ways. For example, the flat heat pipe connected (i.e., through the thermally-conductive insulator 334) to the anode or the cathode of each cell reduces the thermal gradient between the batteries and the TEC and the thermal gradient within the pack. Also for example, through pre-cooling, the TEC and the PCM can lower the temperature of the batteries below ambient, thereby increasing the total capacity for thermal energy within the battery pack during charging and/or discharging cycles.

The embodiments using the TEC 322 can cool the batteries using smaller, quieter, lighter, and more reliable components than those needed for the refrigeration cycle scheme. Because the TECs are smaller and less expensive, the TEC-based thermal management mechanism can be distributed throughout the battery pack assembly 100 and eliminate the need for a coolant loop.

The embodiments using the TEC 322 and the PCM further provide combined advantages of both the vapor-compression scheme and the latent heat storage scheme. The PCM can limit the temperature that the battery pack will see off the charger, and the TECs can add the capability to rapidly remove the heat from the battery pack through pre-cooling or during discharge. The TECs can lower the amount of the PCM necessary in comparison to the latent heat storage scheme, and further provide increased storage capability by lowering the initial temperature of the PCM below ambient temperatures.

The battery module 310 including the TEC 322 connected to the battery cells 112 through the flat heat pipe provides increased efficiency in cooling the battery cells 112 while preserving efficiency and cycle life of the batteries. In comparison to some types of the thermal conductor 118, the flat heat pipe can provide lower thermal resistance and provide an increased contact area for transferring heat from the battery cells 112. The flat heat pipes enable thermal contact to be made with the anode or cathode of each cell, significantly reducing thermal gradients (i.e., negatively affecting efficiency and cycle life of batteries) within the pack.

The battery module 310 including the TEC 322 located above the battery cells 112 and connected to the battery cells 112 through a vertically extending the flat heat pipe further provides increased efficiency in cooling the battery cells 112. The thermal conductivity of the flat heat pipes can be increased when the lower end is hot, and the upper end is cold. Further, This effect benefits the battery pack by adding a thermal diode effect to the cooling system, where the battery pack is more conductive for heat exiting the pack than heat entering the pack. As such, locating the TEC 322 above the battery cells 112 and using vertically extending flat heat pipes can take advantage of the increased thermal conductivity and the diode effect to provide the increased efficiency in cooling the battery cells 112.

The control circuit 132 configured to allocate the incoming power between the battery cells 112 and the TEC 322 provides increased efficiency in charging the battery and preserving the efficiency and life cycle of the batteries. The control circuit 132 can use a variety of parameters as discussed above to control the allocation of power to increase or decrease the amount of cooling appropriate for different situations. The control circuit 132 can effectively allocate sufficient amount of energy for cooling during the charging cycle to prevent the batteries from reaching temperatures that will damage the life cycle or the efficiency of the battery.

Further, the control circuit 132 configured to determine the triggering condition and power the TEC 322 using the electrical energy from the battery cells 112 provides increased durability and robustness of the battery pack assembly 100. The control circuit 132 can be configured to determine situations where cooling the batteries may be more beneficial even without the external power source (i.e., when the internal temperatures of the battery pack assembly 100 exceeds a threshold, during idle times between active discharge cycles, etc.). Based on the determination, the control circuit 132 can enable the battery pack assembly 100 to address the more urgent need to lower the temperature of the battery cells 112, which can prevent the batteries from being damaged by heat.

For illustrative purposes, the battery cells 112 are described as Li-ion batteries. However, it is understood that the battery cells 112 can include different types or chemistries. For example, the battery cells 112 can include pouch cells or nickel-based batteries.

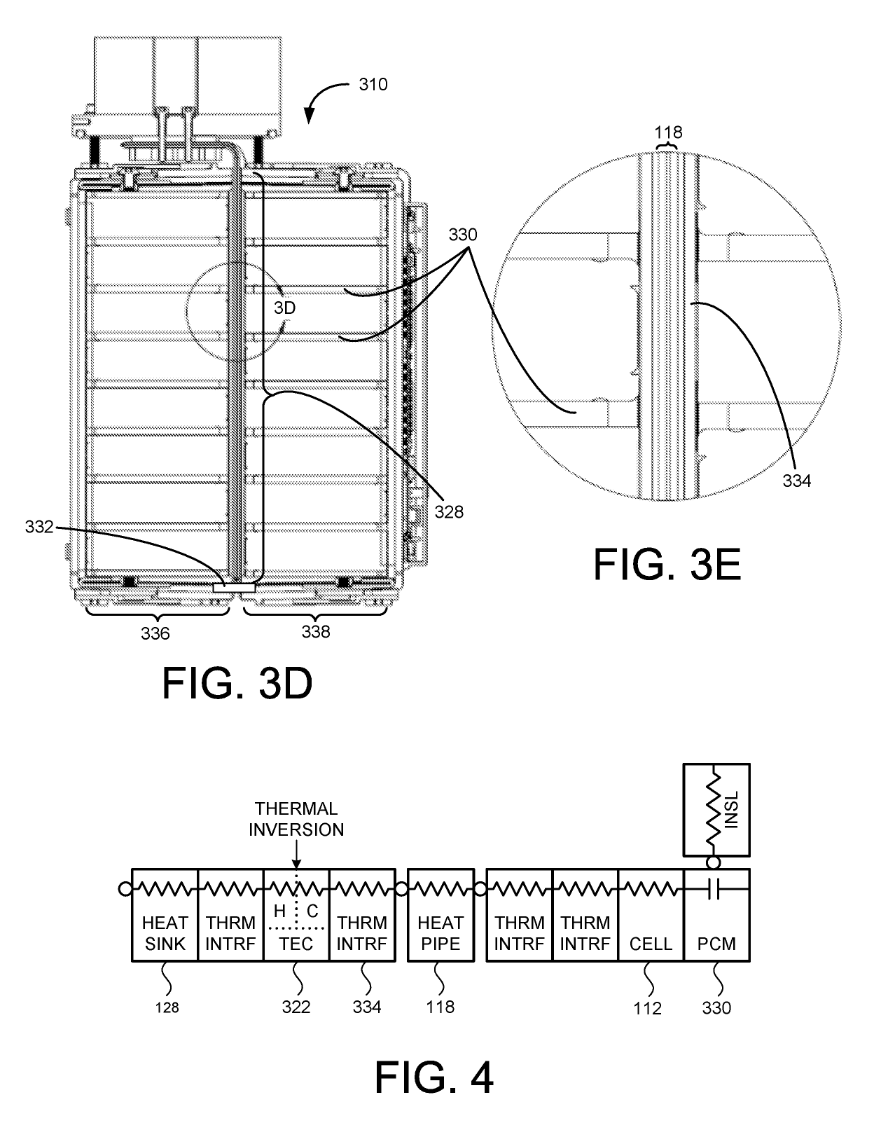

FIG. 4 is a thermal block diagram of the battery pack assembly 100 of FIG. 1 in accordance with an embodiment of the present technology. The thermal block diagram illustrates a path or a process for dissipating or removing thermal energy from the battery cells 112, such as for cooling the battery cells 112 during the discharge cycle or during the charge cycle or the idle state.

The thermal energy can travel through the thermal conductor 118 to the TEC 322. The TEC 322 can remove the thermal energy from the thermal conductor 118, such as by generating a thermal inversion with a heat flux between the cold portion 324 of FIG. 3 of the TEC 322. The corresponding hot portion 326 of FIG. 3 can be connected to the heat sink 128, which can dissipate the thermal energy and transfer the energy outside of the battery pack assembly 100 of FIG. 1.

Between the battery cells 112 and the TEC 322, the thermal energy can travel through one or more interfaces (e.g., direct contact, intervening or adhering material, or a combination thereof) between abutting or adjacent structures. For example, the thermal energy from the battery cells 112 can travel through the thermally-conductive insulator 334 directly contacting the anode or the cathode of the battery cells and the flat heat pipe. Each component and/or interface are represented as resistive elements for the heat transfer.

In some embodiments, the thermal storage unit 330 can be used as a capacitive element for storing the thermal energy, such as energy created during discharge. When the battery cells 112 are not discharging the stored electrical energy, the thermal energy stored in the thermal storage unit 330 can travel through the connected battery cell, and then to the TEC 322 through the thermal conductor 118 and the various interfaces.

During the transfer, the thermal energy can leak at various locations. For example, the thermal energy can leak at one or more of the interfaces between components or structures. Also for example, the thermal energy can leak through the flat heat pipe. Also for example, the thermal energy can leak through the insulation or the housing 102 of FIG. 1.

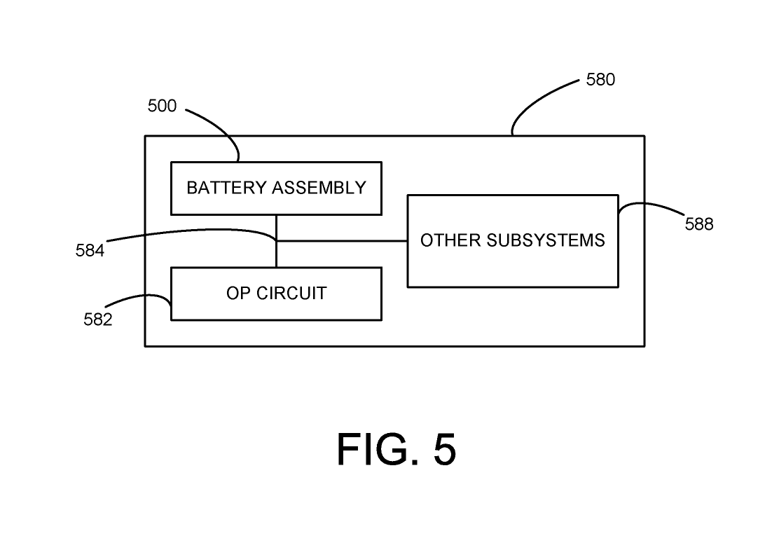

FIG. 5 is a schematic view of a system that includes a battery device in accordance with embodiments of the present technology. Any one of the foregoing battery devices described above with reference to FIGS. 1-4 can be incorporated into any of a myriad of larger and/or more complex systems, a representative example of which is system 580 shown schematically in FIG. 5. The system 580 can include a battery pack assembly 500, an operational circuit 582, an interface 584, and/or other subsystems or components 588. The battery pack assembly 500 can include features generally similar to those of the battery pack assembly described above with reference to FIGS. 1-4, and can therefore include various features for performing the operations discussed above. The resulting system 580 can perform any of a wide variety of functions, such as temperature management of the battery cells. Accordingly, representative systems 580 can include, without limitation, hand-held devices (e.g., mobile phones, tablets, digital readers, and digital audio players), computers, electric vehicles (e.g., drones, electric or hybrid cars, electrically powered boats, etc.) appliances and other products. Components of the system 580 may be housed in a single unit or distributed over multiple, interconnected units (e.g., through interface 584, such as wires, cables, or buses).

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

In the above descriptions, numerous specific details are given to provide a thorough understanding of the invention. However, it will be apparent that the invention may be practiced without these specific details. In order to avoid obscuring an embodiment of the present invention, some well-known circuits or components, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

I/We claim:

1. An electrical battery device, comprising:
a battery cell;
a flat heat pipe, coupled to the battery cell, configured to transfer thermal energy to or from the battery cell; and
a thermal electric cooler, coupled to the flat heat pipe, configured to cool the battery cell based on reducing the thermal energy through the flat heat pipe.

2. The battery device of claim 1, wherein:
the battery cell includes an anode and a cathode; and
the flat heat pipe is connected to the anode or the cathode.

3. The battery device of claim 1, wherein the thermal electric cooler is above the battery cell.

4. The battery device of claim 3, wherein the flat heat pipe includes:
an interface portion connected to the thermal electric cooler; and
a body portion integral with the interface portion and connected to the battery cell, wherein the body portion extends vertically below the thermal electric cooler.

5. The battery device of claim 1, further comprising:
a first battery set including the battery cell and other battery cells, wherein the other battery cells and the battery cells are connected to a first side of the flat heat pipe; and
a second battery set including further battery cells, wherein the further battery cells are connected to a second side of the flat heat pipe opposite the first side.

6. The battery device of claim 1, wherein:
the thermal electric cooler includes a cold portion and a hot portion;
the flat heat pipe is connected to the cold portion of the thermal electric cooler; and
further comprising:
a heat sink connected to the hot portion of the thermal electric cooler.

7. The battery device of claim 6, further comprising:
a thermally-isolative encasing encompassing the battery cell; and
wherein:
the heat sink is above and outside of the thermally-isolative housing.

8. The battery device of claim 1, further comprising a thermal storage unit, coupled to the battery cell, configured to store the thermal energy generated by the battery cell.

9. The battery device of claim 8, wherein the thermal storage unit includes a phase change material.

10. The battery device of claim 8, wherein the thermal storage unit is further connected to the flat heat pipe separate from a connection through the battery cell.

11. A battery assembly, comprising:
a battery cell;
a thermal conductor, coupled to the battery cell, configured to transfer thermal energy to or from the battery cell;
an external power interface configured to receive electrical energy from an energy source separate from the battery cell; and
a thermal electric cooler, coupled to the thermal conductor and electrically coupled to the external power interface, configured to pre-cool the battery cell using the electrical energy directly from the external power interface, wherein pre-cooling is for reducing the thermal energy of the battery cell while charging or before discharging the battery cell.

12. The battery assembly of claim 11, wherein:
the thermal conductor is a flat heat pipe including an interface portion and a body portion extending vertically below the interface portion;
the thermal electric cooler is connected to the interface portion; and
the battery cell is connected to the body portion.

13. The battery assembly of claim 11, wherein the external power interface is electrically coupled to the battery cell for receiving the electrical energy to charge the battery cell.

14. The battery assembly of claim 13 further comprising a control circuit, electrically coupled to the external power interface, configured to allocate the electrical energy between the battery cell and the thermal electric cooler for balancing the thermal energy and a charging rate while charging the battery cell.

15. The battery assembly of claim 11 wherein the thermal electric cooler is further configured to cool the battery cell while discharging electrical energy stored therein.

16. The battery assembly of claim 15 further comprising a control circuit, electrically coupled to the thermal electric cooler and the battery cell, configured to provide electrical energy stored in the battery cell to the thermal electric cooler based on a trigger condition.

17. The battery assembly of claim 11 further comprising a resistive heater, connected to the flat heat pipe opposite to the thermal electric cooler, configured to pre-heat the battery cell.

18. The battery assembly of claim 11 wherein the battery cell is a thermally-conductive battery cell.

19. The battery assembly of claim 11 wherein:
the battery cell is encased in a thermally isolative encasing; and
further comprising:
a high-voltage unit, electrically coupled to the battery cells and located outside of the thermally isolative encasing, configured to control the electrical energy transferred to or from the battery cell.

20. The battery assembly of claim 19 further comprising a package housing encasing the high-voltage unit and the thermally isolative encasing, wherein the package casing includes a cooling channel configured to cool the high-voltage unit after the battery cell.
